(19) United States
(12) Patent Application Publication
(10) Pub. No.: US 2013/0343735 A1
(43) Pub. Date: Dec. 26, 2013

(54) Waterproof Case For Camera And Camera Device Having The Same

(71) Applicant: SHENZHEN AEE TECHNOLOGY CO., LTD., Shenzhen (CN)

(72) Inventor: Xianzhi ZHANG, Shenzhen (CN)

(73) Assignee: SHENZHEN AEE TECHNOLOGY CO., LTD., Shenzhen (CN)

(21) Appl. No.: 13/832,097

(22) Filed: Mar. 15, 2013

(30) Foreign Application Priority Data
Jun. 21, 2012 (CN) 201210207104.0

(51) Int. Cl. G03B 17/08

(52) U.S. Cl. CPC G03B 17/08
USPC 396/25

(57) ABSTRACT

The present disclosure provides a waterproof case for a camera, comprising a front cover for receiving the camera and a rear cover hinged to the front cover, the front cover is secured to the rear cover via a locking structure, wherein an annular waterproof groove is defined in an end surface of a side wall of the front case for receiving a first sealing ring, the waterproof groove extends along a circumferential direction of the end surface and is engageable with a pressing strip arranged at a position on the rear cover corresponding to the waterproof groove to clamp the first sealing ring, and at least one protruding tenon is arranged on the end surface to be engageable with at least one mortise defined at a corresponding position on the rear cover.

### BACKGROUND

1. Technical Field

The present invention relates to technologies of cameras, and particularly, to a waterproof case for a camera and a camera device.

2. Description of Related Art

With the developments of science technologies, cameras have gradually become a part of people's life to allow people to record wonderful moments in life anytime anywhere. However, at present, except some high-end and special cameras, other cameras are not waterproof, which prevents the user from using the camera in rainy days and underwater. If the user wants to take pictures underwater, an expensive professional underwater camera is required, which brings a heavy economical burden on the user. In addition, the previously-owned camera of the user is unavailable, which causes waste.

### SUMMARY

The main object of the present disclosure is to provide a waterproof case for a camera which has good waterproof effect to allow the camera to work in wet environments or work underwater.

The waterproof case provided in the present disclosure includes a front cover for receiving the camera and a rear cover hinged to the front cover, the front cover is secured to the rear cover via a locking structure, wherein an annular waterproof groove is defined in an end surface of a side wall of the front case for receiving a first sealing ring, the waterproof groove extends along a circumferential direction of the end surface and is engageable with a pressing strip arranged at a position on the rear cover corresponding to the waterproof groove to clamp the first sealing ring, and at least one protruding tenon is arranged on the end surface to be engageable with at least one mortise defined at a corresponding position on the rear cover.

Preferably, a tubular lens receiver is formed on the front cover for receiving a lens of the camera; the waterproof case further includes a lens and a pressing ring, the pressing ring secures the lens to an opened end of the lens receiver, and a second sealing ring is clamped between the lens and the opened end of the lens receiver.

Preferably, a number of teeth-shaped protrusions are arranged on one side of the pressing ring contacting the lens, and the protrusions surround the lens, and the protrusions form a rectangular area on the lens with a length-width ratio being equal to 16:9.

Preferably, a grid-shaped reinforcing rib is arranged on an inner surface of the front cover.

Preferably, the locking structure includes a pressing plate and a first locking member hinged to the pressing plate, the pressing plate is hinged to the front cover, and a second locking member lockable to the first locking member is formed on the rear cover.

Preferably, a button is arranged on the front cover for controlling the camera, the button passes through a through hole defined in the side wall of the front cover and a spring to be secured to a locker, and a third sealing ring is arranged between the button and the through hole.

Preferably, a perspective window corresponding to a display of the camera is arranged on the front cover.

Preferably, at least one pad is arranged on the rear cover for abutting the camera.

The present disclosure further provides a camera device including a camera and a waterproof case, the waterproof case includes a front cover for receiving the camera and a rear cover hinged to the front cover and being connected to the front cover via a locking structure, wherein an annular waterproof groove is defined in an end surface of a side wall of the front case for receiving a first sealing ring, the waterproof groove extends along a circumferential direction of the end surface and is engageable with a pressing strip arranged at a position on the rear cover corresponding to the waterproof groove to clamp the first sealing ring, and at least one protruding tenon is arranged on the end surface to be engageable with at least one mortise defined at a corresponding position on the rear cover.

Preferably, a tubular lens receiver is formed on the front cover for receiving a lens of the camera; the waterproof case further includes a lens and a pressing ring, the pressing ring secures the lens to an opened end of the lens receiver, and a second sealing ring is clamped between the lens and the opened end of the lens receiver.

Preferably, a number of teeth-shaped protrusions are arranged on one side of the pressing ring contacting the lens, and the protrusions surround the lens, and the protrusions form a rectangular area on the lens with a length-width ratio being equal to 16:9.

Preferably, a grid-shaped reinforcing rib is arranged on an inner surface of the front cover.

Preferably, the locking structure includes a pressing plate and a first locking member hinged to the pressing plate, the pressing plate is hinged to the front cover; and second locking member lockable to the first locking member is formed on the rear cover.

Preferably, a button is arranged on the front cover for controlling the camera, the button passes through a through hole defined in the side wall of the front cover and a spring to be secured to a locker, and a third sealing ring is arranged between the button and the through hole.

Preferably, a perspective window corresponding to a display of the camera is arranged on the front cover.

Preferably, at least one pad is arranged on the rear cover for abutting the camera.

With the configuration that the first sealing ring is arranged in the waterproof groove, the first sealing ring is capable of engaging with the pressing strip to improve the waterproof effect. In addition, with the configuration, the first sealing ring is prevented from being pressed and impacted by water directly, which prolongs the service life of first sealing ring. When the front cover is locked to the rear cover, the protruding tenon is inserted into the mortise, making the front cover completely correspond to the rear cover and thus avoiding water leakage due to the misplacement between the front cover and the rear cover when the front cover is locked to the rear cover. Moreover, the lens is separable from the front cover, thus, the lens can be replaced according to requirements to meet individual requirements. On the other hand, with the configuration, the situation that the whole waterproof case needs to be replaced due to the damage of the lens, which reduces the cost of the waterproof case.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view illustrating a waterproof case of a camera at an open state;

FIG. 2 is an exploded view showing of a front cover of the waterproof case of FIG. 1; and

FIG. 3 is a schematic view illustrating a waterproof case of a cased at a locked state.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

The present disclosure provides a waterproof case for a camera.

Referring to FIG. 1, which is a schematic view illustrating the waterproof case for a camera at an open state.

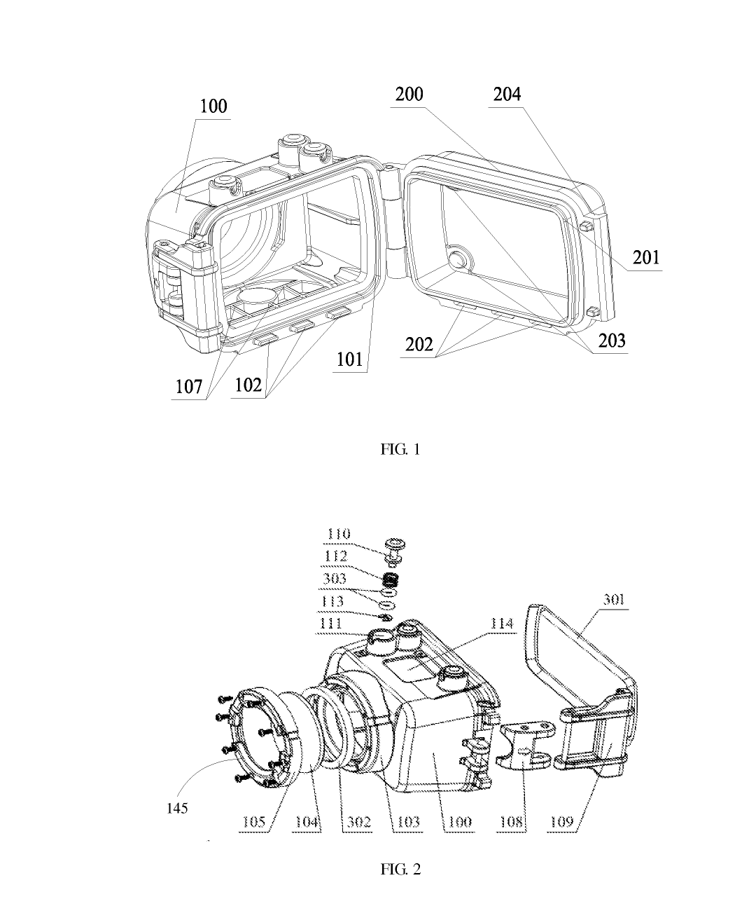

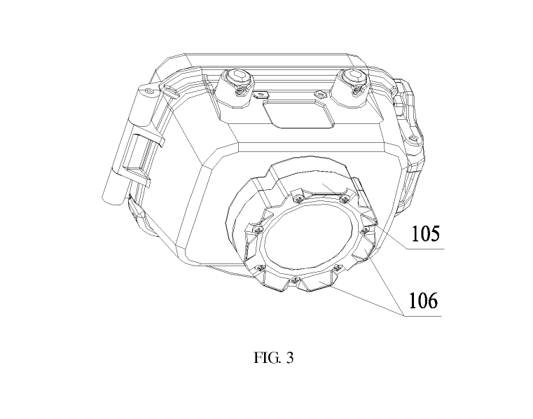

In an embodiment, the waterproof case includes a front cover 100 and a rear cover 200. The front cover 100 is opened at one side thereof. One edge of the front cover 100 is hinged to the rear cover 200, and another edge of the front cover is provided with a locking structure for locking the front cover 100 to the rear cover 200. An annular waterproof groove 101 is defined in an end surface of a side wall of the front cover 100. The waterproof groove 101 is used for receiving a first sealing ring 301 (shown in FIG. 2). A pressing strip 201 is arranged at a position on the rear cover 200 corresponding to the waterproof groove 101. The pressing strip 201 is capable of being received in the waterproof groove 101 to engage with the waterproof groove 101 to clamp the first sealing ring 301.

The front cover 100 and the rear cover 300 can be locked together to form a sealing space for receiving a camera. With the configuration that the first sealing ring 301 is arranged in the waterproof groove 101, the first sealing ring 301 is capable of engaging with the pressing strip 201 to improve the waterproof effect. In addition, with the configuration, the first sealing ring 301 is prevented from being pressed and impacted by water directly, which prolongs the service life of first sealing ring 301.

At least one protruding tenon 102 is arranged on the end surface of the side wall of the front cover 100 to be engageable with at least one mortise 202 defined in the rear cover 200. When the front cover 100 is locked to the rear cover 200, each respective protruding tenon 102 is inserted into the corresponding mortise 202, making the front cover 100 completely correspond to the rear cover 200 and thus avoiding water leakage caused due to the misplacement between the front cover 100 and the rear cover 200 when the front cover 100 is locked to the rear cover 200.

It is understood that the mortise 202 can be defined in the end surface of the side wall of the front cover 100, and the protruding tenon 102 can be arranged on the rear cover 200.

Referring to FIG. 2, which is an exploded view of the front cover of the waterproof case of the camera.

Based on the above embodiment, the front cover 100 can further be provided with a tubular lens receiver 103 for receiving a lens of the camera. The lens receiver 103 is opened at two ends thereof. A pressing ring 105 is secured to the lens receiver 103 via screws, and a lens 104 is clamped between one end of the lens receiver 103 and the pressing ring 105. A waterproof second sealing ring 302 is clamped between the lens 104 and the corresponding end of the lens receiver 103.

The lens 104 is separable from the front cover 100, thus, the lens can be replaced according to requirements to meet individual requirements. On the other hand, with the configuration, the situation that the whole waterproof case needs to be replaced due to the damage of the lens 104, which reduces the cost of the waterproof case.

Based on the above embodiment, a number of protrusions 145 are arranged on one side of the pressing ring 105 opposite to the lens 104. The protrusions 145 surround the lens 104 and are higher than the surface of the lens 104, which can protect the lens 104 from being scratched and damaged. In addition, one ends of the protrusions 145 extend above the lens 104 to form a rectangular area on the lens 104 with a length-width ratio being equal to 16:9, which not only satisfies the large viewing angle requirement of the camera, but also conforms to the trend in which a widescreen display of the camera with a length-width ratio being equal to 16:9 is used for taking and displaying pictures.

Referring to FIG. 1 again, based on the above embodiment, a grid-shaped reinforcing rib 107 is arranged on an inner surface of the front cover 100 for improving the strength of the waterproof case, which keeps the shape of the front cover 100 under great water pressure and thus avoids water leakage caused due to the deformation of the front cover 100.

Referring to FIG. 2 again, based on the above embodiment, the locking structure includes a pressing plate 108 and a first locking member 109. One end of the pressing plate 108 is hinged to the first locking member 109, and the middle portion of the pressing plate 108 is hinged to the side wall of the front cover 100. Under the pressing plate 108, the first locking member 109 is locked to a second locking member 204 formed on the rear cover 200, which allows the front cover 100 to be secured to the rear cover 200 tightly and sealingly.

Referring to FIG. 2 again, based on the above embodiment, the front cover 100 can further be provided with a button 110 for controlling the camera. The button 110 passes through a through hole 111 defined in the side wall of the front cover 100 and a spring 112. One end of the button 110 extending into the front cover 100 is secured to the front cover 100 via a locker 113. A waterproof third sealing ring 303 is arranged between the button 110 and the through hole 111. When the button 110 is pressed down under an outer force, the spring 112 is compressed and the button 110 imposes a force onto a corresponding button of the camera, thereby realizing the controlling of the camera. When the outer force is removed, the button 110 returns to its original state under the driving of the spring 112. With the configuration of the button 110, the camera can be controlled conveniently without removing the waterproof case.

Referring to FIG. 2 again, based on the above embodiment, a perspective window 114 can be arranged on the front cover 100 to correspond to a display of the camera. In this way, the working state of the camera can be observed through the perspective window 114, which eases the operation of the camera.

Referring to FIG. 1 again, based on the above embodiment, the rear cover 200 is further provided with at least one pad 203 on a side thereof facing the front cover 100. The number of the pad 203 is preferably four and the four pads 203 are respectively arranged at four corners of the side of the rear cover 200 facing the front cover 100. Therefore, the pads 203 can stabilize the camera received in the waterproof case by abutting the camera after the front cover 100 and the rear cover 200 are locked together.

Referring to FIG. 3, which is a schematic view illustrating the waterproof case in the locked state. Alternatively, in an embodiment shown in FIG. 3, a number of blocks 106 are arranged on one side of the pressing ring 105 for protecting the lens from being starched and damaged.

The present disclosure further provides a camera device, including a camera and the waterproof case for receiving the camera described in any one of the above embodiments.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A waterproof case for a camera, comprising a front cover for receiving the camera and a rear cover hinged to the front cover, the front cover being secured to the rear cover via a locking structure, wherein an annular waterproof groove is defined in an end surface of a side wall of the front case for receiving a first sealing ring, the waterproof groove extends along a circumferential direction of the end surface and is engageable with a pressing strip arranged at a position on the rear cover corresponding to the waterproof groove to clamp the first sealing ring, and at least one protruding tenon is arranged on the end surface to be engageable with at least one mortise defined at a corresponding position on the rear cover.

2. The waterproof case as claimed in claim 1, wherein a tubular lens receiver is formed on the front cover for receiving a lens of the camera; the waterproof case further comprises a lens and a pressing ring, the pressing ring secures the lens to an opened end of the lens receiver, and a second sealing ring is clamped between the lens and the opened end of the lens receiver.

3. The waterproof case as claimed in claim 2, wherein a number of protrusions are arranged on one side of the pressing ring contacting the lens, the protrusions surround the lens, and the protrusions form a rectangular area on the lens with a length-width ratio being equal to 16:9.

4. The waterproof case as claimed in claim 1, wherein a grid-shaped reinforcing rib is arranged on an inner surface of the front cover.

5. The waterproof case as claimed in claim 1, wherein the locking structure comprises a pressing plate and a first locking member hinged to the pressing plate, the pressing plate is hinged to the front cover, and a second locking member lockable to the first locking member is formed on the rear cover.

6. The waterproof case as claimed in claim 1, wherein a button is arranged on the front cover for controlling the camera, the button passes through a through hole defined in the side wall of the front cover and a spring to be secured to a locker, and a third sealing ring is arranged between the button and the through hole.

7. The waterproof case as claimed in claim 2, wherein a button is arranged on the front cover for controlling the camera, the button passes through a through hole defined in the side wall of the front cover and a spring to be secured to a locker, and a third sealing ring is arranged between the button and the through hole.

8. The waterproof case as claimed in claim 4, wherein a button is arranged on the front cover for controlling the camera, the button passes through a through hole defined in the side wall of the front cover and a spring to be secured to a locker, and a third sealing ring is arranged between the button and the through hole.

9. The waterproof case as claimed in claim 5, wherein a button is arranged on the front cover for controlling the camera, the button passes through a through hole defined in the side wall of the front cover and a spring to be secured to a locker, and a third sealing ring is arranged between the button and the through hole.

10. The waterproof case as claimed in claim 1, wherein a perspective window corresponding to a display of the camera is arranged on the front cover.

11. The waterproof case as claimed in claim 1, wherein at least one pad is arranged on the rear cover for abutting the camera.

12. A camera device, comprising a camera and a waterproof case, the waterproof case comprising a front cover for receiving the camera and a rear cover hinged to the front cover and being connected to the front cover via a locking structure, wherein an annular waterproof groove is defined in an end surface of a side wall of the front case for receiving a first sealing ring, the waterproof groove extends along a circumferential direction of the end surface and is engageable with a pressing strip arranged at a position on the rear cover corresponding to the waterproof groove to clamp the first sealing ring, and at least one protruding tenon is arranged on the end surface to be engageable with at least one mortise defined at a corresponding position on the rear cover.

13. The camera device as claimed in claim 12, wherein a tubular lens receiver is formed on the front cover for receiving a lens of the camera; the waterproof case further comprises a lens and a pressing ring, the pressing ring secures the lens to an opened end of the lens receiver, and a second sealing ring is clamped between the lens and the opened end of the lens receiver.

14. The camera device as claimed in claim 13, wherein a number of teeth-shaped protrusions are arranged on one side of the pressing ring contacting the lens, and the protrusions surround the lens, and the protrusions form a rectangular area on the lens with a length-width ratio being equal to 16:9.

15. The camera device as claimed in claim 12, wherein a grid-shaped reinforcing rib is arranged on an inner surface of the front cover.

16. The camera device as claimed in claim 12, wherein the locking structure comprises a pressing plate and a first locking member hinged to the pressing plate, the pressing plate is hinged to the front cover; and second locking member lockable to the first locking member is formed on the rear cover.

17. The camera device as claimed in claim 12, wherein a button is arranged on the front cover for controlling the camera, the button passes through a through hole defined in the side wall of the front cover and a spring to be secured to a locker, and a third sealing ring is arranged between the button and the through hole.

18. The camera device as claimed in claim 12, wherein a perspective window corresponding to a display of the camera is arranged on the front cover.

19. The camera device as claimed in claim 12, wherein at least one pad is arranged on the rear cover for abutting the camera.
